(19) United States
(12) Patent Application Publication
(10) Pub. No.: US 2011/0193525 A1
(43) Pub. Date: Aug. 11, 2011

(54) BATTERY PACK

(75) Inventor: Huntae Ro, Yongin-si (KR)

(73) Assignee: Samsung SDI Co., Ltd., Yongin-si (KR)

(21) Appl. No.: 12/979,128

(22) Filed: Dec. 27, 2010

(30) Foreign Application Priority Data
Feb. 11, 2010 (KR) 10-2010-0012798

(51) Int. Cl. H02J 7/00

(52) U.S. Cl. 320/116

(57) ABSTRACT

Provided is a battery pack for a portable computer, which can be charged using a mobile phone charger. The battery pack includes battery cells connected in series, a controller electrically connected to the battery cells to sense voltages of the battery cells, and performing a cell balancing operation to make the voltages of the battery cells equal to each other. The battery pack also includes a charge circuit electrically connected to each of the plurality of battery cells, and sequentially supplying a charge voltage in a time-divisional manner to each of the battery cells in response to a control signal of the controller.

### CROSS-REFERENCE TO RELATED APPLICATION

This application claims the benefit of Korean Patent Application No. 10-2010-0012798, filed Feb. 11, 2010 in the Korean Intellectual Property Office, the disclosure of which is incorporated herein by reference.

### BACKGROUND

1. Field

Aspects of the present invention relate to a battery pack.

2. Description of the Related Art

In general, a power supply device for a portable computer such as a notebook computer or a net book includes a battery pack capable of charging, and a charger (adapter) that can be exclusively used for a battery pack. The charger is referred to as a battery pack dedicated charger or merely as a battery pack charger, hereinafter.

The battery pack generally includes 3-9 battery cells and a protection circuit. In recent years, lithium ion batteries or lithium polymer batteries have been typically used as the battery cells. In addition, the battery cells are usually connected in series to each other, and supply a direct-current (DC) voltage of approximately 10 to 20 V to a portable computer. The battery pack charger also supplies a DC voltage of approximately 10 to 20 V for charging the battery pack and for use as a power supply of the portable computer.

As described above, since the battery pack dedicated charger supplies a DC voltage of approximately 10 to 20 V to be used to charge the battery pack and to be supplied as power of the portable computer, it is generally bulky and heavy. Furthermore, since most of portable computer manufacturers are practically focusing on research into and development of portable computers with reduced size and weight, research into smaller, lightweight chargers has been neglected. This leaves a problem associated with portability of a portable computer, which may be caused because the battery pack charger is still bulky and heavy. That is to say, it is quite inconvenient for a user to carry the battery pack charger in addition to the portable computer.

### SUMMARY

Aspects of the present invention provide a battery pack for a notebook computer, which can be charged using a mobile phone charger.

In accordance with one aspect of the present invention, there is provided a battery pack including a plurality of battery cells connected in series, a controller electrically connected to the plurality of battery cells to sense voltages of the plurality of battery cells, and performing a cell balancing operation to make the voltages of the plurality of battery cells equal to each other, and a charge circuit electrically connected to each of the plurality of battery cells, and sequentially supplying a charge voltage in a time-divisional manner to each of the plurality of battery cells in response to a control signal of the controller.

According to an aspect of the invention, the charge circuit may supply a charge voltage smaller than a battery pack voltage to each of the battery cells.

According to an aspect of the invention, the charge circuit may supply a charge voltage in a range between 2.5 to 4.25 V to each of the battery cells.

According to an aspect of the invention, a mobile phone charger may be electrically connected to the charge circuit.

According to an aspect of the invention, the charge circuit may stop a charging operation when a voltage of a battery cell currently being charged is 5 to 15 mV greater than that of the other battery cell that is not currently charged.

According to an aspect of the invention, a charge switch turned on or off by the controller may further be connected between the mobile phone charger and the charge circuit.

According to an aspect of the invention, the controller may control the charge switch to be turned on when a charge voltage smaller than the battery pack voltage is supplied to the battery pack.

According to an aspect of the invention, the controller may control the charge switch to be turned off when a charge voltage greater than the battery pack voltage is supplied to the battery pack.

According to an aspect of the invention, sensing wires for sensing voltages of each of the plurality of battery cells may be connected between the controller and each of the plurality of battery cells, and the charge circuit may supply the charge voltage to each of the plurality of battery cells through the sensing wires.

According to an aspect of the invention, the charge circuit may include a positive electrode switch that electrically connects a positive electrode terminal of a mobile phone charger and a positive electrode of a battery cell selected among the plurality of battery cells, a negative electrode switch that electrically connects a negative electrode terminal of the mobile phone charger and a negative electrode of the selected battery cell, and a charge controller that simultaneously turns on or off the positive electrode switch and the negative electrode switch.

According to an aspect of the invention, the charge circuit may sequentially turn on the positive electrode switch and the negative electrode switch installed corresponding to each of the plurality of battery cells in a time-divisional manner.

In accordance with another aspect of the present invention, there is provided a battery pack including a plurality of battery cells connected in series, a controller electrically connected to the plurality of battery cells to sense voltages of the plurality of battery cells, and performing a cell balancing operation to make the voltages of the plurality of battery cells equal to each other, and a booster circuit electrically connected to the plurality of battery cells, and boosting a charge voltage in response to a control signal of the controller to supply the boosted charge voltage to each of the plurality of battery cells.

According an aspect of the invention, a mobile phone charger may be electrically connected to the booster circuit.

According to an aspect of the invention, a charge voltage, which is smaller than a battery pack voltage, may be input to the booster circuit.

According to an aspect of the invention, a charge voltage in a range between 2.5 to 4.25 V may be input to the booster circuit.

According to an aspect of the invention, the controller may output a control signal to enable the booster circuit to be operable when a charge voltage smaller than the battery pack voltage is supplied to the battery pack.

According to an aspect of the invention, the controller may not output a control signal to disable the booster circuit to be operable when a charge voltage greater than the battery pack voltage is supplied to the battery pack.

According to an aspect of the invention, a battery pack-positive electrode terminal may be connected to a positive electrode terminal of a battery cell having the highest potential among the plurality of battery cells, and an output voltage of the booster circuit may be supplied to the battery pack-positive electrode terminal.

According to an aspect of the invention, a battery pack-negative electrode terminal may be connected to a negative electrode terminal of a battery cell having the lowest potential among the plurality of battery cells, and a ground voltage of the booster circuit may be supplied to the battery pack-negative electrode terminal.

According to an embodiment of the present invention, the battery pack mounted on a portable computer can be charged using a mobile phone charger using a relatively low voltage. That is to say, a charge voltage that is a relatively low voltage output from a mobile phone charger is sequentially supplied to a plurality of battery cells, thereby easily charging the battery pack without having to use of a battery pack charger.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a circuit diagram of a battery pack according to an embodiment of the present invention;

FIG. 2 is a circuit diagram of a charge circuit of the battery pack shown in FIG. 1;

FIGS. 3A and 3B are a circuit diagram and a timing diagram of an exemplary charge controller of the battery pack shown in FIG. 1;

FIG. 4 is a circuit diagram of an exemplary balancing circuit of the battery pack shown in FIG. 1;

FIG. 5 is a circuit diagram of a battery pack according to another embodiment of the present invention;

FIG. 6A illustrates a state in which a portable computer and its battery pack charger are connected to each other, and FIG. 6B illustrates a state in which a battery pack for a portable computer and a mobile phone charger are connected to each other;

FIG. 7 is a flowchart illustrating a charging method of the battery pack according to an embodiment of the present invention, as shown in FIG. 1; and

FIG. 8 is a flowchart illustrating a charging method of the battery pack according to another embodiment of the present invention, as shown in FIG. 5.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

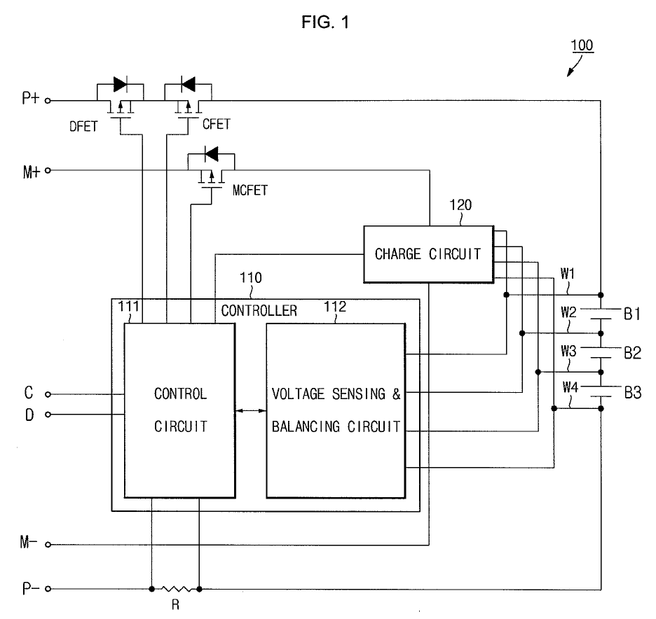

FIG. 1 is a circuit diagram of a battery pack 100 according to an embodiment of the present invention. As shown in FIG. 1, the battery pack 100 includes a plurality of battery cells B1, B2 and B3 connected in series to each other, a controller 110, a charge circuit 120, and a charge switch MCFET. While shown as included in the battery pack 100, it is understood that the battery cells B1, B2 and B3 could be detachable from the battery charging elements of the battery pack 100. Moreover, the controller 110 and the charge circuit 120 could be separately included in a battery pack charger connectable to the battery cells B1, B2 and B3.

A mobile phone-positive electrode terminal M+ and a mobile phone-negative electrode terminal M− are electrically connected to the charge circuit 120. A battery pack-positive electrode terminal P+ and a battery pack-negative electrode terminal P−are electrically connected to each of the battery cells B1 and B3. In addition, a charge switch CFET and a discharge switch DFET are electrically connected between the battery pack-positive electrode terminal P+ and the battery cell B1. A current sense resistor R is electrically connected between the battery pack-negative electrode terminal P− and the battery cell B3.

A mobile phone charger supplies a relatively low voltage in a range between approximately 2.5 to approximately 4.25 V. The mobile phone charger is connectable to the mobile phone-positive electrode terminal M+ and the mobile phone-negative electrode terminal M−. A battery pack charger supplies a relatively high voltage in a range between approximately 5.0 to approximately 20 V. The battery pack charger is connectable to the battery pack-positive electrode terminal P+ and the battery pack-negative electrode terminal P−. While described as a mobile phone charger, it is understood that other chargers having lower voltages can be used, such as those used for game systems, media players, etc.

The plurality of battery cells B1, B2 and B3 are connected in series to each other. Of course, other battery cells may be further connected in parallel to the battery cells B1, B2 and B3, respectively. Although 3 battery cells B1, B2 and B3 connected in series are illustrated in the current embodiment, 2 battery cells or 4 or more battery cells may be connected in series. The battery cells B1, B2 and B3 may be at least one selected from lithium ion batteries, lithium polymer batteries, and equivalents thereof, but aspects of the present invention are not limited thereto.

The controller 110 includes a control circuit 111 and a voltage sensing and balancing circuit 112. The controller 110 may be generally formed as a single integrated circuit chip, but aspects of the present invention are not limited thereto. The control circuit 111 turns off the charge switch CFET or MCFET or the discharge switch DFET in an event of over-charge, over-discharge or over-current of the battery pack 100. In addition, the control circuit 111 has a clock terminal C and a data terminal D, and communicates with external devices using these terminals. The voltage sensing and balancing circuit 112 senses the respective voltages of the battery cells B1, B2 and B3 and the overall voltage of the battery pack 100 through sensing wires W1, W2, W3 and W4. Of course, the overall voltage of the battery pack should be higher than the voltage of each of the individual battery cells B1, B2, B3. The voltage sensing and balancing circuit 112 performs a cell balancing operation to make the respective voltages of the battery cells B1, B2 and B3 substantially equal to each other. In addition, the controller 110 outputs a control signal to turn on or off the charge switch MCFET. Further, the controller 110 may offer a clock signal to the charge circuit 120. In addition, the controller 110 outputs a control signal to turn on or off the charge switch MCFET or the discharge switch DFET.

When connected to the mobile phone charger, the charge circuit 120 sequentially supplies a charge voltage from the mobile phone charger in a time-divisional manner to the respective battery cells B1, B2 and B3. To perform this function, the charge circuit 120 is electrically connected to the mobile phone-positive electrode terminal M+ and the mobile phone-negative electrode terminal M−. In addition, the charge circuit 120 is electrically connected to the respective battery cells B1, B2 and B3 through the sensing wires W1, W2, W3 and W4. That is to say, the charge circuit 120 sequentially provides the charge voltage to the respective battery cells B1, B2 and B3 in a time-divisional manner using the sensing wires W1, W2, W3 and W4.

The charge switch MCFET is electrically connected between the mobile phone-positive electrode terminal M+ and the charge circuit 120. In addition, the charge switch MCFET has a control electrode electrically connected to the control circuit 111. The charge switch MCFET is turned on or off by the controller 110. For example, when a charge voltage (e.g., 3 V), which is smaller than the battery pack voltage (e.g., 9 V), is supplied to the battery pack 100, the controller 110 turns on the charge switch MCFET. Of course, the charge voltage is applied from the mobile phone charger through the mobile phone-positive electrode terminal M+ and the mobile phone-negative electrode terminal M−. However, when a charge voltage (e.g., 10 V), which is greater than the battery pack voltage, is supplied to the battery pack 100, the controller 110 turns off the charge switch MCFET. Here, the charge voltage is applied from the battery pack charger through the battery pack-positive electrode terminal P+ and the battery pack-negative electrode terminal P−. In addition, when it is determined that the battery cells B1, B2 and B3 are overcharged, the controller 110 turns off the charge switch MCFET, thereby preventing the battery cells B1, B2 and B3 from being deteriorated due to the overcharging.

As described above, the mobile phone-positive electrode terminal M+ is connected to the charge circuit 120, and the mobile phone-negative electrode terminal M− is also connected to the charge circuit 120. That is to say, the mobile phone-positive electrode terminal M+ and the battery pack-positive electrode terminal P+ are electrically disconnected or isolated from each other. In addition, the mobile phone-negative electrode terminal M− and the battery pack-negative electrode terminal P− are also electrically disconnected or isolated from each other. Further, the mobile phone charger supplies a charge voltage (e.g., 2.5 to 4.25 V) which is smaller than the battery pack voltage (e.g., 9 V). The mobile phone charger is connected to the mobile phone-positive electrode terminal M+ and the mobile phone-negative electrode terminal M−.

The battery pack-positive electrode terminal P+ is electrically connected to the positive electrode of the battery cell B1 having the highest potential. The battery pack-negative electrode terminal P−+ is electrically connected to the negative electrode of the battery cell B3 having the lowest potential (i.e., ground potential). As described above, the battery pack-positive electrode terminal P+ is electrically disconnected from the mobile phone-positive electrode terminal M+, and the battery pack-negative electrode terminal P− is also electrically disconnected from the mobile phone-negative electrode terminal M−.

In practice, the battery pack-positive electrode terminal P+ and the battery pack-negative electrode terminal P− are connected with the battery pack charger. For example, if the battery pack 100 is mounted into a portable computer, the battery pack-positive electrode terminal P+ and the battery pack-negative electrode terminal P− may be power input terminals installed in the portable computer. Here, in order to prevent simultaneous charging operations from being performed by the mobile phone charger and the battery pack charger, the mobile phone-positive electrode terminal M+ and the mobile phone-negative electrode terminal M− are installed in the battery pack 100 itself. That is to say, the mobile phone-positive electrode terminal M+ and the mobile phone-negative electrode terminal M− are not exposed outside the portable computer while the battery pack-positive electrode terminal P+ and the battery pack-negative electrode terminal P− are exposed outside the portable computer through the power input terminals, which will further be described below.

However, it is understood that aspects of the example are not limited to the battery pack 100 having the mobile phone-negative electrode terminal M− and positive terminal M+ which are not exposed while the battery pack 100 is in the computer. For instance, the battery pack 100 could allow the mobile phone-negative electrode terminal M− and positive terminal M+ to be exposed while the pack is in the computer so as to allow a user a choice of using the mobile phone-negative electrode terminal M− and positive terminal M+ without removing the battery pack 100 from the computer. Conversely, it is understood that the battery pack 100 could allow charging through the battery pack-positive electrode terminal P+ and the battery pack-negative electrode terminal P− while the battery pack 100 is removed from the computer.

The charge switch CFET and the discharge switch DFET are electrically connected between the battery pack-positive electrode terminal P+ and the battery cell B1. When any one of the battery cells B1, B2 and B3 is at an overcharged state, the charge switch CFET is turned off by the control signal of the controller 110, thereby interrupting charging. When any one of the battery cells B1, B2 and B3 is at an over discharged state, the discharge switch CFET is turned off by the control signal of the controller 110, thereby interrupting discharging. Of course, if the mobile phone-positive electrode terminal M+ and the mobile phone-negative electrode terminal M− are connected to the mobile phone charger so that any one of the battery cells B1, B2 and B3 is at an overcharged state, the controller 110 turns off the charge switch MCFET.

The current sense resistor R is electrically connected between the battery pack-negative electrode terminal P− and the negative electrode of the battery cell B3 having the lowest potential. The current sense resistor R senses charge current or discharge current and transmits the same to the controller 110. Thus, the controller 110 turns off the charge switch CFET or the discharge switch DFET based on information regarding the charge current or the discharge current obtained from the current sense resistor R. In addition, the controller 110 turns off the charge switch MCFET based on information regarding the charge current obtained from the current sense resistor R.

As described above, the battery pack 100 according to an embodiment of the present invention can be charged by the mobile phone charger supplying a low voltage as well as the battery pack charger. In other words, according to an embodiment of the present invention, a small amount of charge voltage supplied from the mobile phone charger is sequentially supplied to the battery cells B1, B2 and B3 in a time-divisional manner, thereby charging all of the plurality of battery cells B1, B2 and B3 connected in series.

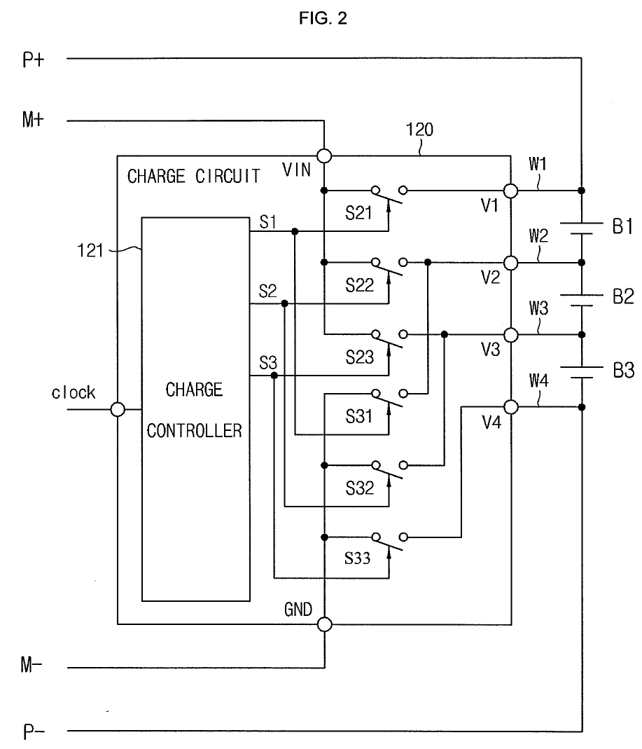

FIG. 2 is a circuit diagram of the charge circuit 120 of the battery pack shown in FIG. 1. As shown in FIG. 2, the charge circuit 120 includes a charge controller 121, and a plurality of switches S21, S22, S23, S31, S32, S33. Of course, the charge circuit 120 is electrically connected to the battery cells B1, B2 and B3 through a plurality of sensing wires W1, W2, W3 and W4.

In addition, the charge controller 121 may receive, for example, a clock signal. The clock signal may be supplied from the controller 110. Of course, a clock generator may be incorporated into the charge circuit 120. The charge controller 121 may output, for example three high-level signals S1, S2 and S3.

The charge circuit 120 has an input terminal VIN, to which the mobile phone-positive electrode terminal M+ is connected. In addition, the charge circuit 120 has a ground terminal GND, to which the mobile phone-negative electrode terminal M− is connected.

Three switches S21, S22 and S23 are connected to the input terminal VIN, and three switches S31, S32 and S33 are connected to the ground terminal GND. Here, the switches S21, S22, S23, S31, S32 and S33 are turned on or off by control signals S1, S2 and S3 output from the charge controller 121. That is to say, the switches S21 and S31 are simultaneously turned on or off by the control signal S1. The switches S22 and S32 are simultaneously turned on or off by the control signal S2. The switches S23 and S33 are simultaneously turned on or off by the control signal S3. While three sets of switches are shown, it is understood that the number of sets can vary depending on the number of batteries.

The switch S21 is electrically connected to a terminal V1. In addition, the terminal V1 is connected to the positive electrode of the battery cell B1 through a first sensing wire W1. The switch S22 is electrically connected to a terminal V2. In addition, the terminal V2 is connected to the negative electrode of the battery cell B1 through a second sensing wire W2. Further, the second sensing wire W2 is connected to the positive electrode of the battery cell B2. In addition, the terminal V2 is electrically connected to the switch S31.

The switch S23 is electrically connected to a terminal V3. In addition, the terminal V3 is connected to the negative electrode of the battery cell B2 through a third sensing wire W3. Further, the third sensing wire W3 is connected to the positive electrode of the battery cell B3. In addition, the terminal V3 is electrically connected to the switch S32.

The switch S33 is electrically connected to a ground terminal V4. In addition, the ground terminal V4 is connected to the negative electrode of the battery cell B3 through a fourth sensing wire W4.

In such a manner, according to an example of the present invention, when a high-level control signal S1 is output from the charge controller 121, the switch S21 and the switch 31 are turned on. Here, the control signals S2 and S3 are low-level signals such that switches S22, S23, S32, S33 are turned off.

A closed loop is formed by the mobile phone-positive electrode terminal M+, the input terminal VIN, the switch S21, the terminal V1, the first sensing wire W1, the battery cell B1, the second sensing wire W2, the terminal V2, the switch S31, the ground terminal GND and the mobile phone-negative electrode terminal M−. Accordingly, the battery cell B1 is charged. Here, the charging operation is not terminated until a voltage difference between the battery cell B1 and the other battery cell B2 or B3 becomes approximately 5 to 15 mV. That is to say, if the voltage difference between the voltage of the battery cell B1 and the other battery cell B2 or B3 exceeds 5 to 15 mV, a time required for a cell balancing operation may be extended or the battery cells B1, B2 and B3 may deteriorate.

When a high-level control signal S2 is output from the charge controller 121, the switch S22 and the switch 32 are turned on. Here, the control signals S1 and S3 are low-level signals and switches S21, S23, S31, S33 are turned off.

A closed loop is formed by the mobile phone-positive electrode terminal M+, the input terminal VIN, the switch S22, the terminal V2, the second sensing wire W2, the battery cell B2, the third sensing wire W3, the terminal V3, the switch S32, the ground terminal GND and the mobile phone-negative electrode terminal M−. Accordingly, the battery cell B2 is charged. Here, the charging operation is not terminated until a voltage difference between the battery cell B2 and the other battery cell B1 or B3 becomes approximately 5 to 15 mV.

When a high-level control signal S3 is output from the charge controller 121, the switch S23 and the switch S33 are turned on. Here, the control signals S1 and S2 are low-level signals and switches S21, S22, S31, S32 are turned off.

A closed loop is formed by the mobile phone-positive electrode terminal M+, the input terminal VIN, the switch S23, the terminal V3, the third sensing wire W3, the battery cell B3, the fourth sensing wire W4, the terminal V4, the switch S33, the ground terminal GND and the mobile phone-negative electrode terminal M−. Accordingly, the battery cell B3 is charged. Here, the charging operation is not terminated until a voltage difference between the battery cell B3 and the other battery cell B1 or B2 becomes approximately 5 to 15 mV. Accordingly, the battery cell B3 is charged. Here, the charging operation is not terminated before a voltage difference between the battery cell B3 and the other battery cell B1 or B2 becomes approximately 5 to 15 mV.

As described above, according to an embodiment of the present invention, the battery pack 100 can be sequentially charged in a time-divisional manner using the mobile phone charger supplying a voltage smaller than the overall voltage of the battery pack.

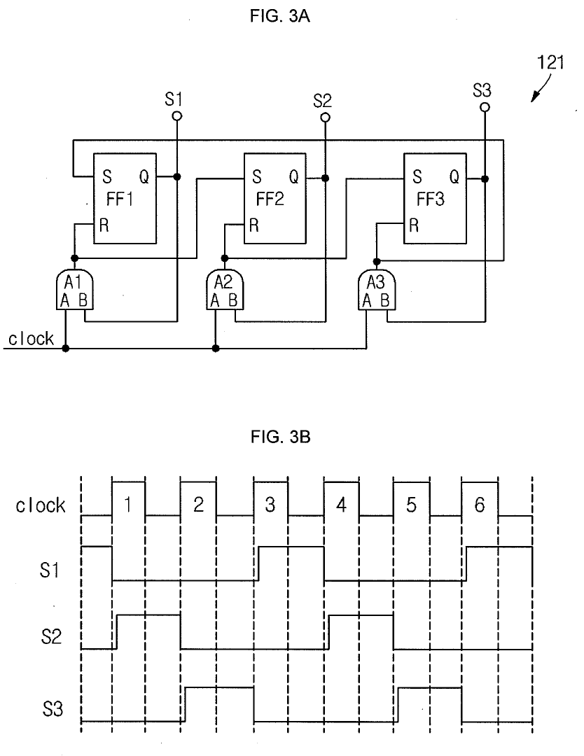

FIGS. 3A and 3B are a circuit diagram and a timing diagram of an exemplary charge controller of the battery pack 100 shown in FIG. 1. As shown in FIG. 3A, the charge controller 121 includes three flipflops FF1, FF2 and FF3, and three AND gates A1, A2 and A3. Each of the flipflops FF1, FF2 and FF3 includes an S terminal, an R terminal and a Q terminal. Control signals S1, S2 and S3 are output through the respective Q terminals. Each of the AND gates A1, A2 and A3 receives a clock signal through its A terminal, and receives an output signal of the Q terminal of each flipflop through its B terminal. Output terminals of the AND gates are connected to the R terminals of the flipflops. In addition, the output terminal of each of the AND gates is connected to the S terminal of the flipflop adjacent thereto. The output terminal of the third AND gate A3 is connected to the S terminal of the first flipflop FF1.

As shown in FIG. 3B, the clock signal is supplied with a constant frequency. In an exemplary embodiment, assumptions are made that the control signal S1 of high level is output through the Q terminal of the first flipflop FF1, and the control signals S2 and S3 of low level are output through the Q terminals of the second and third flipflops FF2 and FF3. In such a state, the high-level signal output through the Q terminal of the flipflop FF1 is also input through the B terminal of the AND gate A1. In addition, the high-level clock signal is input to the A terminals of the AND gates A1, A2 and A3.

Since low-level signals are output through the Q terminals of the flipflops FF2 and FF3, low-level signals are input to the B terminals of the AND gates A2 and A3.

If high-level signals are simultaneously input through the A terminal and the B terminal of the AND gate A1, the AND gate A1 will output high-level signals, which are simultaneously input to the R terminal of the flipflop FF1 and the S terminal of the flipflop FF2. Thus, the flipflop FF1 outputs the low-level signal S1 through the Q terminal, and the flipflop FF2 outputs the high-level signal S2 through the Q terminal.

Then, a high-level signal is input to the B terminal of the AND gate A2. In addition, a low-level signal is input to the B terminal of the AND gate A1.

In such a manner, the charge controller 121 sequentially outputs the high-level signals S1, S2 and S3. Consequently, the sequentially output high-level signals S1, S2 and S3 turn on sequentially a pair of switches S21 and S31, a pair of switches S22 and S32, and a pair of switches S23 and S33. According as the pairs of the switches S21 and S31, the pair of switches S22 and S32, and the pair of switches S23 and S33 are sequentially turned on, the battery cells B1, B2 and B3 are sequentially charged.

It should be understood by those of ordinary skill in the art that the charge controller 121 sequentially outputting high-level signals S1, S2 and S3 may exist in various manners in addition to the circuit shown herein and that all the circuits that sequentially output high- or low-level signals may be applied to the scope of the present invention.

In order to prevent the high-level signals 51, S2 and S3 from overlapping each other, time delay circuits may further be connected between the output terminal of the AND gate A1 and the S terminal of the flipflop FF2, between the output terminal of the AND gate A2 and the S terminal of the flipflop FF3, and between the output terminal of the AND gate A3 and the terminal of the flipflop FF3.

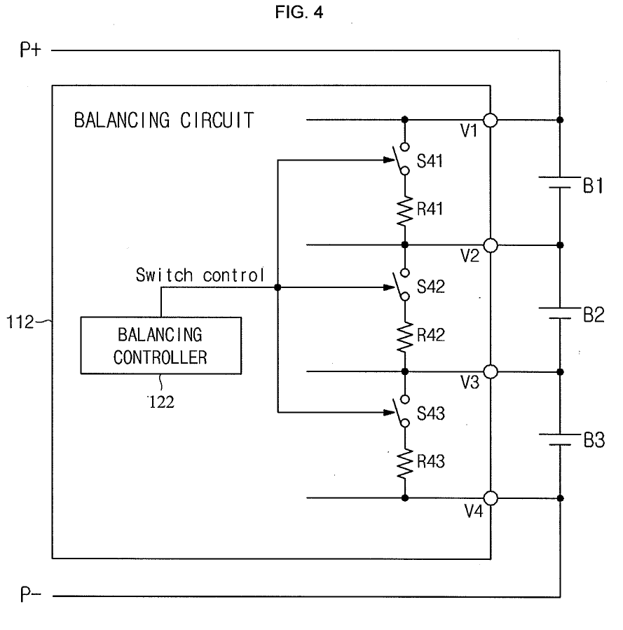

FIG. 4 is a circuit diagram of an exemplary balancing circuit 122 of the battery pack 100 shown in FIG. 1. As shown in FIG. 4, the balancing circuit 112 according to the current embodiment has a switch and a resistor connected in parallel for each of the battery cells B1, B2 and B3. Here, the switch and the resistor are connected in series to each other. For example, a switch S41 and a resistor R41 are connected to the battery cell B1. A switch S42 and a resistor R42 are connected to the battery cell B2. A switch S43 and a resistor R43 are connected to the battery cell B3.

In addition, the switches S41, S42 and S43 are turned on or off by a balancing controller 122. For example, assume the battery cell B1 has a relatively higher voltage as compared to the battery cells B2 and B3. In addition, assume the battery cells B2 and B3 have the same voltage. Then, the balancing controller 122 turns on the switch S41. Therefore, the battery cell B1 is discharged through the resistor R41. The discharging operation continues until the voltage of the battery cell B1 becomes equal to that of the battery cell B2 or B3.

In an exemplary embodiment, the cell balancing operation is performed when a voltage difference between each of the battery cells B1, B2 and B3 is greater than or equal to 5 to 15 mV. That is to say, a time-divisional, sequential charging operation of a selected battery cell, for example, the battery cell B1, is performed until a voltage difference between the battery cell B1 and the other battery cell B2 or B3 becomes approximately 5 to approximately 15 mV. Therefore, if the cell balancing operation is performed when the voltage difference between the battery cell B1 and the other battery cell B2 or B3, the cell balancing operation and the time-divisional, sequential charging operation may interfere with each other.

As described above, in the battery pack 100 according to an embodiment of the present invention, the balancing circuit 112 can maintain the voltages of the battery cells B1, B2 and B3 to be substantially the same with one another.

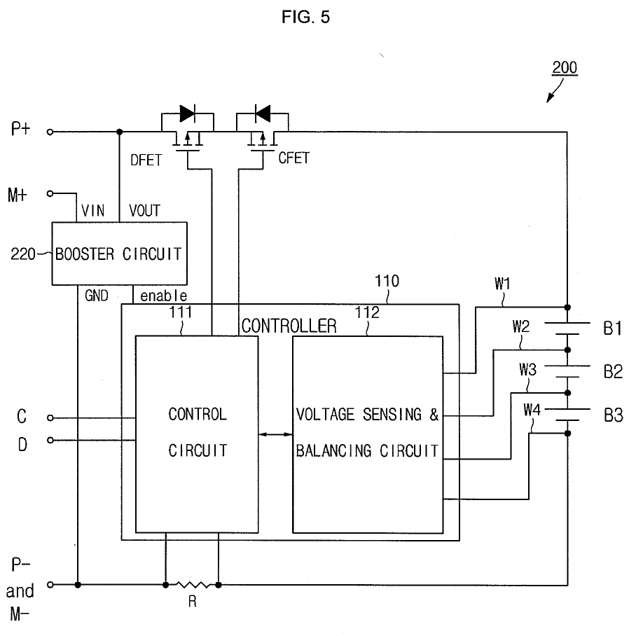

FIG. 5 is a circuit diagram of a battery pack 200 according to another embodiment of the present invention. As shown in FIG. 5, the battery pack 200 includes a booster circuit 220. The booster circuit 220 includes a mobile phone-positive electrode terminal M+ and a mobile phone-negative electrode terminal M−. Here, the mobile phone-positive electrode terminal M+ is formed separately from the battery pack-positive electrode terminal P+. However, the mobile phone-negative electrode terminal M− may be formed along with the battery pack-negative electrode terminal P−. In addition, a charge voltage boosted by the booster circuit 220 is supplied to the battery pack-positive electrode terminal P+. Accordingly, the boosted charge voltage from the booster circuit 220 is collectively supplied to the battery cells B1, B2 and B3 through a charge switch CFET and a discharge switch DFET. Therefore, overcharging of the battery cells B1, B2 and B3 can be prevented by the charge switch CFET. In addition, the mobile phone-negative electrode terminal M− is also formed at the battery pack-negative electrode terminal P−, thereby allowing charge current to be sensed by a current sense resistor R.

A mobile phone charger supplying a charge voltage in a range between approximately 2.5 to approximately 4.25 V is connectable to the mobile phone-positive electrode terminal M+ and the mobile phone-negative electrode terminal M−. That is to say, a voltage (e.g., 3 V), which is smaller than the overall voltage (e.g., 9 V) of the battery pack 200, is supplied through the mobile phone-positive electrode terminal M+ and the mobile phone-negative electrode terminal M−.

Meanwhile, when a charge voltage (e.g., 3 V), which is smaller than the battery pack voltage, is supplied to the battery pack 200, the controller 110 outputs a control signal ‘enable’ to the booster circuit 220 to enable the booster circuit 220 to be operable. In other words, as described above, since the charge voltage supplied from the mobile phone charger is smaller than the battery pack voltage, the controller 110 outputs the control signal to the booster circuit 220, thereby allowing the booster circuit 220 to boost the charge voltage supplied from the mobile phone charger.

Of course, when a charge voltage greater than the battery pack voltage is supplied to the battery pack 200, the controller 110 does not output a control signal, thereby disabling the booster circuit 220. That is to say, the charge voltage supplied from the battery pack charger through the battery pack-positive electrode terminal P+ and the battery pack-negative electrode terminal P− should be greater than the battery pack voltage. In this case, the controller 110 disables the operation of the booster circuit 220.

In such a manner, according to an aspect of the present invention, the battery pack 200 can be charged using the mobile phone charger supplying a charge voltage smaller than the battery pack voltage.

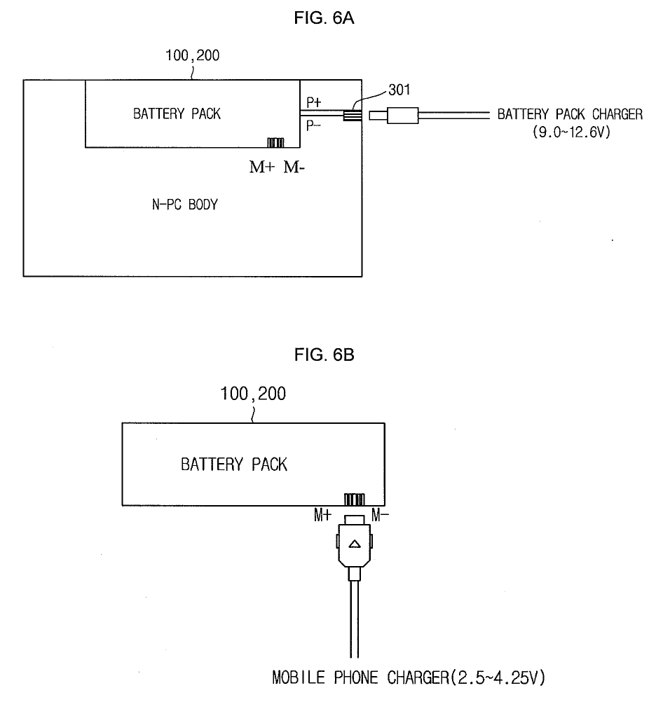

FIG. 6A illustrates a state in which a portable computer and its battery pack charger are connected to each other, and FIG. 6B illustrates a state in which a battery pack for a portable computer and a mobile phone charger are connected to each other. As shown in FIG. 6A, where the battery packs 100 and 200 are combined with a portable computer, a charging operation is performed through a power input terminal 301. The power input terminal 301 is connected to a battery pack-positive electrode terminal P+ and a battery pack-negative electrode terminal P−. A battery pack charger supplying a charge voltage of, for example, approximately 9.0 to approximately 12.6 V, is connected to the power input terminal 301, and the battery packs 100 and 200 are charged by the battery pack charger. Here, a mobile phone-positive electrode terminal M+ and a mobile phone-negative electrode terminal M−, which are not exposed outside the portable computer, are provided in each of the battery packs 100 and 200. That is to say, in order to prevent charging operations from being simultaneously performed by the battery pack charger and the mobile phone charger, once the battery packs 100 and 200 are combined with the portable computer, the mobile phone charger is not connected to the battery packs 100 and 200.

As shown in FIG. 6B, in a case where the battery packs 100 and 200 are detached from the mobile computer, the mobile phone-positive electrode terminal M+ and the mobile phone-negative electrode terminal M− are exposed to the outside. Thus, the mobile phone charger may be electrically connected to the battery packs 100 and 200. Here, since the mobile phone charger supplies a charge voltage of approximately 2.5 to approximately 4.25 V, the battery cells B1, B2 and B3 are sequentially charged in a time-divisional manner. Alternatively, the battery cells B1, B2 and B3 are charged after boosting the charge voltage. While shown as hiding the terminals M+ and M− using the PC body, it is understood that the terminals M+ and M− can be hidden and exposed selectively without removing the battery pack 100, 200. Also, while shown as included in the battery pack 200, it is understood that the battery cells B1, B2 and B3 could be detachable from the battery charging elements of the battery pack 200. Moreover, the charging elements including the controller 110 and the circuit 120, 220 could be separately included in a battery pack charger connectable to the battery cells B1, B2 and B3.

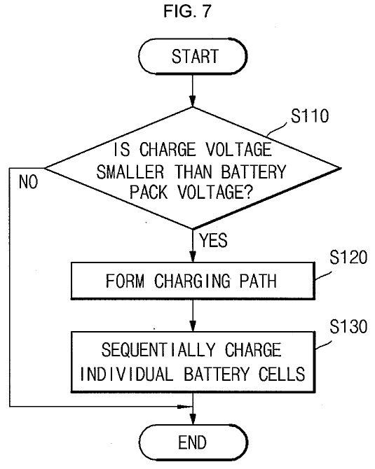

FIG. 7 is a flowchart illustrating a charging method of the battery pack 100 shown in FIG. 1 according to an embodiment of the present invention. As shown in FIG. 7, the charging method of the battery pack according to an embodiment of the present invention includes comparing a charge voltage with a battery pack voltage (S110), forming a charging path (S120), and sequentially charging individual battery cells (S130). In practice, the charging method of the battery pack of FIG. 7 is implemented in the battery pack 100 shown in FIG. 1.

In operation S110, the charge voltage input to each of the battery cells is compared with the battery pack voltage. If a mobile phone charger is connected to a mobile phone-positive electrode terminal M+ and a mobile phone-negative electrode terminal M−, the input charge voltage should be smaller than the battery pack voltage.

If a battery pack charger is connected to a battery pack-positive electrode terminal P+ and a battery pack-negative electrode terminal P−, the input charge voltage should be greater than the battery pack voltage.

In operation S120, when the charge voltage input as the comparison result of the operation S110 is smaller than the battery pack voltage, a charging path is formed. That is to say, the controller 110 turns on a charge switch MCFET, thereby allowing the charge voltage to be supplied to the charge circuit 120 through the mobile phone-positive electrode terminal M+. That is to say, the controller 110 controls the charge voltage from the mobile phone charger to be supplied to the charge circuit 120.

In operation S130, the charge circuit 120 sequentially charges the respective battery cells B1, B2 and B3 in a time-divisional manner. For example, the battery cell B1 is first charged, the battery cell B2 is then charged, and the battery cell B3 is finally charged. The charging operation is performed until all the battery cells B1, B2 and B3 are fully charged, or until at least 80% the charge capacity of each of the battery cells B1, B2 and B3 is reached.

If it is determined that at least one of the battery cells B1, B2 and B3 is overcharged, the controller 110 turns off the charge switch MCFET, thereby preventing the battery cells B1, B2 and B3 from being overcharged.

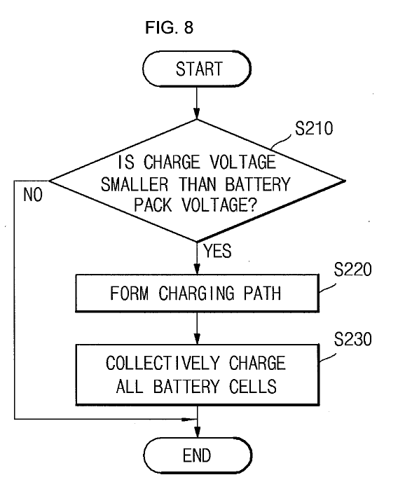

FIG. 8 is a flowchart illustrating a charging method of the battery pack 200 shown in FIG. 5 according to another embodiment of the present invention. As shown in FIG. 8, the charging method of the battery pack includes comparing a charge voltage with a battery pack voltage (S210), forming a charging path (S220), and collectively charging all the battery cells (S130). In practice, the charging method of the battery pack is implemented in the battery pack 200 shown in FIG. 5.

In operation S210, the input charge voltage is compared with the battery pack voltage. If a mobile phone charger is connected to a mobile phone-positive electrode terminal M+ and a mobile phone-negative electrode terminal M−, the input charge voltage should be smaller than the battery pack voltage. If a battery pack charger is connected to a battery pack-positive electrode terminal P+ and a battery pack-negative electrode terminal P−, the input charge voltage should be greater than the battery pack voltage.

In operation S220, when the charge voltage input as the comparison result of the operation S110 is smaller than the battery pack voltage, a charging path is formed. That is to say, the controller 110 outputs a control signal ‘enable’ to the booster circuit 220, thereby enabling the booster circuit 220 to be operable.

In operation S230, the charge voltage boosted by the booster circuit 220 is collectively supplied to the battery cells B1, B2 and B3 connected in series. Of course, the boosted charge voltage should be higher than the battery pack voltage. Accordingly, the battery pack 200 is normally charged by the booster circuit 220.

If it is determined that at least one of the battery cells B1, B2 and B3 is overcharged, the controller 110 turns off the charge switch CFET, thereby preventing the battery cells B1, B2 and B3 from being overcharged.

While not required in all aspects, all or elements of the controller can be implemented using computer software and/or firmware encoded on a computer readable medium and implemented using one or more general or special purpose processors.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A battery pack comprising:
a plurality of battery cells connected in series;
a controller electrically connected to the plurality of battery cells to sense voltages of the plurality of battery cells, the controller electrically performing a cell balancing operation to make the voltages of the plurality of battery cells equal to each other; and
a charge circuit electrically connected to each of the plurality of battery cells, the charge circuit sequentially supplying a charge voltage in a time-divisional manner to each of the plurality of battery cells in response to a control signal of the controller.

2. The battery pack of claim 1, wherein the charge voltage supplied by the charge circuit to each of the battery cells is smaller than a battery pack voltage supplied by the plurality of battery cells.

3. The battery pack of claim 1, wherein the charge voltage supplied by the charge circuit to each of the battery cells is in a range between 2.5 to 4.25 V.

4. The battery pack of claim 1, further comprising a terminal connectable to a mobile phone charger and which is electrically connected to the charge circuit.

5. The battery pack of claim 1, wherein the charge circuit stops a charging operation of each cell when a voltage of the one battery cell currently being charged is 5 to 15 mV greater than a voltage of another one of the battery cells that is not currently being charged.

6. The battery pack of claim 4, further comprising a charge switch connected between the terminal and the charge circuit, wherein the controller controls the charge switch to be turned on or off.

7. The battery pack of claim 6, wherein:
the controller controls the charge switch to be turned on when the charge voltage is supplied to the battery pack, and
the charge voltage is smaller than a battery pack voltage supplied by the plurality of battery cells.

8. The battery pack of claim 6, wherein:
the controller controls the charge switch to be turned off when another charge voltage is supplied to the battery pack, and
the another charge voltage is at or greater than a battery pack voltage supplied by the plurality of battery cells.

9. The battery pack of claim 1, further comprising sensing wires for sensing the voltages of each of the plurality of battery cells and which are connected between the controller and the plurality of battery cells, wherein the charge circuit supplies the charge voltage to the plurality of battery cells through the sensing wires.

10. The battery pack of claim 1, wherein the charge circuit comprises:
a positive electrode switch that electrically connects a positive electrode terminal connectable to a mobile phone charger and a positive electrode of a battery cell selected among the plurality of battery cells;
a negative electrode switch that electrically connects a negative electrode terminal connectable to the mobile phone charger and a negative electrode of the selected battery cell; and
a charge controller that simultaneously turns on or off the positive electrode switch and the negative electrode switch.

11. The battery pack of claim 10, wherein the charge circuit sequentially turns on the positive electrode switch and the negative electrode switch corresponding to each of the plurality of battery cells in a time-divisional manner.

12. A battery pack comprising:
a plurality of battery cells connected in series;
a controller electrically connected to the plurality of battery cells to sense voltages of the plurality of battery cells, the controller performing a cell balancing operation to make the voltages of the plurality of battery cells equal to each other; and
a booster circuit electrically connected to the plurality of battery cells, the booster circuit boosting a charge voltage in response to a control signal of the controller to supply the boosted charge voltage to each of the plurality of battery cells.

13. The battery pack of claim 12, further comprising a terminal connectable to a mobile phone charger and which is electrically connected to the booster circuit.

14. The battery pack of claim 12, wherein the charge voltage input to the booster circuit is smaller than a battery pack voltage supplied by the plurality of battery cells.

15. The battery pack of claim 12, wherein the charge voltage input to the booster circuit is in a range between 2.5 to 4.25 V.

16. The battery pack of claim 14, wherein the controller outputs a control signal to enable the booster circuit to be operable when the charge voltage smaller is supplied to the battery pack.

17. The battery pack of claim 12, wherein:
the controller does not output a control signal and disables the booster circuit when another charge voltage is supplied to the battery pack, and
the another charge voltage is at or greater than the battery pack voltage.

18. The battery pack of claim 12, further comprising a battery pack-positive electrode terminal which is connected to a positive electrode terminal of one of the battery cells having a highest potential among the plurality of battery cells, wherein the boosted charge voltage output from the booster circuit is supplied to the battery pack-positive electrode terminal.

19. The battery pack of claim 12, further comprising a battery pack-negative electrode terminal which is connected to a negative electrode terminal of one of the battery cells having a lowest potential among the plurality of battery cells, wherein a ground voltage of the booster circuit is supplied to the battery pack-negative electrode terminal.
